(19) United States
(12) Patent Application Publication
(10) Pub. No.: US 2026/0322221 A1
(43) Pub. Date: Oct. 15, 2026

(54) DIGITALISED DYNAMOELECTRIC MACHINE HAVING INVERTER MODULES

(71) Applicant: Innomotics GmbH, 90441 Nümberg (DE)

(72) Inventors: Konrad Brandl, Thalmassing (DE); MARKUS HÖSLE, Erlangen (DE)

(73) Assignee: Innomotics GmbH, 90441 Nümberg (DE)

(21) Appl. No.: 19/483,649

(22) PCT Filed: Apr. 15, 2024
(86) PCT No.: PCT/EP2024/060115

§ 371 Date: Jan. 15, 2026

(30) Foreign Application Priority Data
May 11, 2023 (EP) 23172859.3

(51) Int. Cl. H02K 11/35; H02K 9/06; H02K 9/22; H02K 11/33; H02K 17/16

(52) U.S. Cl. CPC H02K 11/35; H02K 9/06; H02K 9/227; H02K 11/33; H02K 17/168

(57) ABSTRACT

A drive includes a rotary dynamoelectric machine which includes a plurality of inverter modules. A predeterminable number of physical and/or chemical sensors are provided on and/or within the drive and are assigned to at least one or more portions of the rotary dynamoelectric machine and/or to one or more inverter modules. The drive includes an evaluation and/or control unit that allows at least a provisional evaluation of data detected by the sensors. Communication from the evaluation and/or control unit to at least a cloud and/or to the inverter modules is made possible in predefinable time intervals and/or data packets.

The invention relates to a drive with a dynamoelectric machine with inverter modules, to a method for operating such a dynamoelectric machine with inverter modules, and to the use of such a drive.

Moreover, the invention relates to a computer program product.

Furthermore, the invention relates to a digital twin of such a drive.

Winding systems of stators of dynamoelectric machines are constructed from winding wires or conductor bars that are arranged in slots of a magnetically conductive body of the stator.

If the winding system does not consist of a distributed three-phase winding by means of cables or wires, but of a number of conductor bars, a high current intensity is however required because of the comparatively low inductance. This high current intensity only needs a comparatively low voltage (<100 V) because of the low ohmic resistance of the conductor bars. This low voltage makes it possible for inverter modules with which the conductor bars are activated to be arranged at relatively small distances from one another on the dynamoelectric machine.

These conductor bars are connected to one another by way of a short-circuiting ring on one end face of the magnetically conductive body of the stator, and are fed by respectively assigned inverter modules on the other end face of the magnetically conductive body, as is known for example from DE 10 2005 032 965 A1.

Instead of the complex, labor-intensive distributed stator winding, the practice is therefore to revert to a low-cost, robust bar winding. Depending on the operating conditions, each individual stator slot is fitted with a conductor bar. Each conductor bar has previously been connected to its own power electronics for supplying power and control, the inverter module. The magnetic field necessary for operating the machine is generated by high currents (up to several 1000 A) in the conductor bars, with at the same time low voltages.

These low voltages resulting from the winding concept consequently make it possible for the entire drive, that is to say the dynamoelectric machine with the power electronics installed in the inverter modules, to be of a compact and high-performance construction.

In the case of the previous classic drives, measured-value recording for the monitoring or control of a drive can take place for example by way of sensor boxes on the housing of the dynamoelectric machine. These contain, inter alia, temperature sensors and magnetic field meters, which however, depending on the mounting location of the sensor box on the housing of the dynamoelectric machine, deliver respective measurement signals. However, even at the respective mounting locations, only a summary measured-value recording is performed

On this basis, the invention addresses the problem of providing an aforementioned drive with improved control and/or monitoring.

The solution to the stated problem is achieved by a drive with a rotary dynamoelectric machine with a number of inverter modules,
wherein the rotary dynamoelectric machine has a stator and a rotor,
wherein the stator has a winding system in a magnetically conductive body, in particular a laminated core, wherein the stator and the rotor are separated from one another by an air gap,
wherein the winding system is arranged in slots of the magnetically conductive body which face the air gap,
wherein the winding system has for each slot in particular a conductor bar divided into subconductors, the subconductors of which are in electrical contact with at least one inverter module at a first end of the conductor bar and the subconductors of which are electrically combined with the other subconductors of the further conductor bars arranged in the respective slots to form a short-circuiting ring at the other end, that is to say the second end, of the conductor bar, on the other end face of the magnetically conductive body of the stator,
wherein a predeterminable number of physical and/or chemical sensors, which are assigned to at least one or more portions of the rotary dynamoelectric machine and/or one or more inverter modules, are provided on and/or within the drive,
wherein the drive is assigned at least one evaluation and/or control unit which makes at least a provisional evaluation of data recorded by the sensors possible,
wherein communication from the evaluation and/or control unit to at least one cloud and/or to the inverter modules in predeterminable time intervals and/or data packets is made possible.

The solution to the stated problem is also achieved by a method for operating and/or monitoring and/or simulating a drive according to the invention by the following steps:
recording at least some of the data in and on the drive by means of suitable sensors and/or recording means,
transmitting the data recorded to at least one evaluation and/or control unit, wherein at least a provisional evaluation of the data takes place there,
wherein, depending on the evaluation, operating parameters, such as voltage and/or current, are selectively recorded, evaluated, monitored and controlled by way of the inverter module or modules to subconductor levels of a stator of a dynamoelectric machine.

The solution to the stated problem is also achieved by a digital twin system of a drive according to the invention having:
a physical part with a physical drive for driving a working machine,
a virtual part with a digital image of the drive, sensors and recording elements for recording data of the drive inside and/or outside the drive,
at least one data transfer element for data transfer between the physical part and the virtual part,
wherein the data can be transferred by the data transfer element to the virtual part, wherein the digital image of the drive can be changed in dependence on the data transmitted.

The solution to the stated problem is also achieved by a computer program product for simulating an operating behavior of a drive according to the invention which drives a working machine.

The fact that the generation of the magnetic field in the stator of the dynamoelectric machine can now be controlled by an individual conductor bar (or even individual subconductors or subconductor bundles of the conductor bar), and consequently to slot level or subconductor slot level, by means of software assigned to an inverter module, provides entirely new possibilities for digital penetration of a drive, and consequently of the rotating electric machine, the inverter modules, and further component parts of the drive, such as bearings, couplings, etc.

For reasons of accessibility, previously electrical variables, such as the current and voltage of the drive, have mostly only been picked up at the connection terminals of the rotating electric machine. Although this summary measured-value recording does for example allow the state of an asymmetry in the electrical measured variables to be detected, it is scarcely possible to influence this due to the topology of the dynamoelectric machine (contiguous winding, etc.).

This is now being improved with lasting effect by a drive according to the invention and its method, in that the drive is “penetrated” by a predeterminable number of physical and chemical sensors and recording elements. In this case, the following data for the drive can be recorded by corresponding sensors or other recording elements, in particular location-dependently or time-dependently:
using measuring instruments for recording the ambience, such as the atmospheric humidity, temperature, pressure, noises, etc.,
recording the following winding parameters in the conductor bar or the respective subconductors in one or more slots of the stator, such as the temperature, partial discharge, applied voltage, current flow, oscillations, magnetic field, system perturbations,
recording the following rotor data, such as the temperature, magnetic field, oscillations, vibrations,
recording the following bearing data, such as the temperature, lubricating state, thermal or rheological behavior of a lubricant, lubricant pressure, flow rate of the lubricant, viscosity characteristics of the lubricant, partial discharges in the lubricant, oscillations, vibrations,
picking up the cooling data, such as temperatures in the respective cooling circuits, circulated amounts of cooling medium,
recording data of the electric rotating machine, such as the rotational speed and/or a slip, pulsating torques, foundation vibrations, overload, efficiency, system perturbations,
the materials of the drive, the dynamoelectric machine, coupling, bearing, etc., such as the modulus of elasticity, stiffness, anisotropy factor, thermal characteristics, such as the theraml expansion behavior, may also have already been stored in a digital twin.

Depending on the types of sensor and physical or chemical parameters (temperature, vibration, abrasion, etc.), predeterminable sampling rates or time constants must be taken into account in the evaluation or control.

These data are fed to an evaluation unit or a control, and can also be fed by way of corresponding data connections to a digital twin of the drive.

With the drive concept taken as a basis here, in which the magnetomotive force for each stator slot of the dynamoelectric machine can be influenced by way of a separate inverter module, the electrical variables of current and voltage can be recorded to slot level—if only one conductor bar is provided for each slot—and if need be, depending on the operating conditions, selectively evaluated and controlled.

If, however, for each slot the conductor bar is divided into a number of subconductors, which possibly are respectively assigned to an own inverter module, the electrical variables of current and voltage can even be recorded for each subconductor or subconductor bundle and if need be, depending on the operating conditions, even selectively evaluated and controlled for each subconductor or subconductor bundle.

On the basis of the data recorded, pole changing or partial disconnection (individual conductor bars are not energized, or only slightly) of the electric machine for example can be brought about. Similarly, redundancy requirements for the drive can be satisfied.

Furthermore, an asymmetrical current distribution in the conductor bars may be set in order to counteract an unwanted magnetic pull in the air gap of the electric machine.

Previously supplied sensors (for example temperature, vibrations) only delivered summary values, that is to say measured values for component parts or the entire drive. On account of the drive concept according to the invention, the data can be recorded not in a finely granular form but also correspondingly evaluated and the drive then correspondingly corrected. This has the effect for example that the current and voltage can be recorded and adjusted to the slot level or even subconductor level of a conductor bar.

On the basis of the finely granular data recording, conclusions can be drawn concerning summation of the measured values, which inter alia also benefits subsequent types of drive, in that only a necessary number of sensors and recording elements have to be provided in the drive.

It is consequently also possible to compare the summarily formed measured values with the singular measured values and, by selective changing of individual magnetomotive forces through the slot/subconductor, to record the effect on the component part, the entire drive and a working machine and for example set the total vibration value at the bearing plate, a coupling or the housing to a minimum by selective correction of the magnetomotive forces through the slot/subconductor.

In principle, the data of a sensor positioned at any point on and/or in the drive can consequently be transmitted to the control, be taken into account in a control strategy, predetermine the required current and/or required voltage by way of the inverter module for the conductor bar or the subconductor or the subconductor bundle in the slot, and consequently adapt the entire drive and/or machine behavior to this extent.

On account of the large number of possibilities for controlling this drive, a correspondingly large number of sensors for real-time monitoring can be positioned on and in the drive. These sensors consequently also deliver data for a digital twin and/or also maintenance intervals, and possibly an optimization for subsequent models of these drives.

It is consequently possibly the case with subsequent models-which rely on the same digital twin—that less effort is necessary for data recording.

In addition or as a result, knowledge of the electrical variables at slot level/subconductor level allows the component stresses (vibration dampers at the motor foot; bearing loads; loads on the coupling in relation to the working machine, etc.) to be very strictly limited, which leads to considerably improved state analysis and lifetime assessment. Maintenance intervals can consequently be maxed out.

All of the data specified above that are fed to the evaluation and/or control unit of the drive, concerning the drive, the bearings, the coupling, the working machine, temperatures of cooling media (not shown), sound emissions, torsional vibrations of the shaft, etc., are supplementarily or partly-evaluated made available to a digital twin. The data are not only transferred from the evaluation and/or control unit of the drive to the digital twin, but it is also possible to initiate required measures of the drive from the digital twin. There is consequently a bidirectional data connection which allows feedback from and to the drive, and its way of working can be actively monitored and influenced.

As an alternative to this, it is possible to use a comparatively small number of sensors—for example only on the coupling—by means of AI (artificial intelligence) (possibly fed from the digital twin of another predecessor machine (learning machine)) to conclude the operating data of this current drive.

With the digitalization of the drive inter alia to slot level/subconductor level and the possibility of intervening in a controlling manner in the behavior of the machine, a series of advantages for the electric machine and/or a working machine are obtained, such as minimizing the vibration behavior, minimizing the noise behavior, maximizing the efficiency, minimizing pulsating torques, optimizing the synchronization properties, improving the analysis of component stresses of the component parts and improving the availability assessment of the component parts of the drive.

Such a method for operating such a drive with an electric rotating machine, in particular a motor or a generator, is used for example in an industrial environment with numerous automated processes in order to coordinate maintenance intervals or if need be initiate countermeasures at an early time.

To determine the behavior of the drive with its component parts and its working machine, high-performance models of these component parts, for example of the electric rotating machine, are provided in the cloud, for example calculated by a thermal simulator, in particular on the basis of the finite element method, and/or determined empirically by measurements.

The cloud is in particular an IT Infrastructure, in which for example storage space, computing power and application software are provided as services via the Internet.

With the aid of the in the cloud, on the basis of the data provided from the drive, corresponding models can be provided and can be used for initiating actions for the current drive.

Alternatively, the cloud is used to provide a simple mathematical model, which for example is approximated from a complex physical model and is further processed in the evaluation and/or control unit with little computational effort. A means for determining required drive parameters is for example a computing unit which comprises in particular a microprocessor with a memory.

The respective models (thermal model, vibration model, model of the mechanical loads, etc.) of the drive or its component parts may be provided in the cloud or digital twin, so that complex calculations at least partially take place in the cloud. Consequently, the power consumption of the evaluation and/or control unit is comparatively low.

Particularly advantageously, the data picked up by the sensors and recording elements are transferred wirelessly to the evaluation unit. A wireless transfer of these data takes place for example via Bluetooth LE or RFID. A wireless transfer of the sensor data does not influence actual operation, for example by disturbing cables. In addition, in particular passive, wireless temperature sensors are inexpensive and easy to mount on and in the machine.

Means for determining further operating parameters are for example at least one sensor for measuring a physical parameter of the electric rotating machine, and a microprocessor, which determines an operating parameter from the physical parameter. The accuracy, and consequently the reliability, of the monitoring of the drive are increased by the inclusion of additional operating parameters.

In the case of parameterizable models, the accuracy of the respective determination is increased by the inclusion of further relevant operating parameters.

The stated problem is similarly solved by a computer program product according to the invention. The computer program product is designed to simulate operating behavior of a drive which can be used in an industrial application. For this purpose, the drive is replicated in its construction in the computer program product and has properties relevant to the operating behavior that can be set overall and/or in relation to component parts.

The computer program product may comprise a physical model with which the operating behavior of the drive can be adjusted while taking into account the properties that can be set. For setting the properties, the computer program product may have at least one data interface, by way of which the properties can be set by a user input and/or an input from a further simulation-directed computer program product.

Equally, the data interface can be used to predetermine an indication of the present operating state, for example present axial forces, radial forces, tilting moments and/or rotational speeds of the shaft.

The operating behavior for example of the shaft arrangement with the bearings, as part of the drive, may include a spatially resolved lubricant film thickness, a spatially resolved lubricant temperature, a lubricant loss, a present mechanical stress, and/or a contribution to wear according to a damage model.

The simulated operating behavior can be output by way of a further data interface of the computer program product to a user and/or a further simulation-directed computer program product. By means of the computer program product according to the invention, such a drive can especially be optimized for use in an industrial application by simulation,

The computer program product may for example also be formed as a so-called digital twin.

A digital twin in the sense according to the invention is a digital representation of a tangible or intangible object—that is to say the drive with its component parts, such as dynamoelectric machines, inverter modules, bearings, couplings, etc.—from the real world in the digital world. Digital twins make a comprehensive data exchange possible. They are more than just data and have models (for example a thermal model, vibration model, magnetic field model, forces model, etc.) of the drive represented, or its component parts, and may in addition include simulations, algorithms and services which describe, monitor or influence properties or behaviors of the drive represented, or offer additional services.

This also involves the communication between the real drive and the virtual drive. Consequently, data flow from the real drive to the virtual drive, as well as information from the virtual drive to the real drive or the process that can be influenced by it. The comparison and the analysis of the deviations between the real drive and the virtual drive allow the real drive possibly to be adapted to one another again, and consequently their influenceable processes, such as compressors or conveyor belts, to be correspondingly regulated.

One possibility here is that the virtual object, that is to say the virtual drive, is guiding in this digital twin concept, to which the real object, that is to say the real drive, must adapt itself. In the case of technical installations, a readjustment of a component part of the installation, or for example also predictive maintenance, may be deduced from the deviations occurring.

Consequently, the definition of the digital twin according to the invention also comprises the control of the drive or its component parts on the basis of real-time data, so that the following archetypes known per se exist: Basic Digital Twin, Enriched Digital Twin, Autonomous Control Twin, Enhanced Autonomous Control Twin, Exhaustive Twin.

The drive with its digital twin is consequently part of the industry 4.0 concept, which has the following design principles:
interconnection: the aim is to interconnect the entire drive of machines, devices, sensors and people, preferably via the Internet of Things.
Information transparency: sensor data are intended to expand information systems of digital models in order thereby to create a virtual image of the real drive world of this drive or drivetrain.
Furthermore, this is intended to ensure technical assistance, with which informed decisions about the way in which the drive operates can be taken and problems occurring can be solved more quickly.
It is also intended to make it possible that decentralized decisions can also be taken within the drive. Only in definable exceptions, for example when there are malfunctions or conflicts of aims in the drivetrain, is a higher authority contacted.

Decentralized decisions are for example enforcing cooling when there is an increase in temperatures, in that an external fan is switched on or operated at greater speed.

Decisions which are for example taken by a higher authority are deciding on the operating behavior of the dynamoelectric machine when it is found locally that there are partial discharges.

According to the invention, the drive is embedded in the Internet of Things (IoT). IoT is used here to refer to a global infrastructure of information companies which make it possible to interconnect physical and virtual objects and allow the drives to work together by information and communication technologies.

The Internet of Things refers to the linking of uniquely identifiable physical objects with a virtual representation in an Internet-like structure.

The aim of the IoT is to automatically record relevant information from the real world of the drive, link it together and make it available in the network. The aim is therefore that the dynamoelectric machine, the inverter modules, etc. make their status information available for further processing in the network. The network may be local, self-contained as a VPN or else connected to the Internet by way of separately protected firewalls.

Such status information may be information about the current use, about aging, but also about particular environmental conditions or operating behaviors at the location of the drive. Such information may be evaluated to improve the usability of the drive (early detection of maintenance or exchange, etc.).

The drive with its digital twin forms a so-called cyber-physical system. This refers to a combination of informational, software-technical component parts with mechanical and electronic parts, which communicate by way of a data infrastructure, such as for example the Internet. The formation of such a cyber-physical system arises from the interconnection of embedded systems by wire-bound or wireless communication networks.

The fact that the data of the drive and/or its component parts are transmitted to the virtual part allows, for example by artificial intelligence (AI), the operation of the drive to be optimized for different loading states by selective intervention by way of the individual inverter modules in the magnetic-field-forming current at the respective slot levels.

The respective data transmission of component parts of the drive may take place constantly and/or cyclically. The respective data transfer element transfers these data, whereupon the digital image of the drive, and consequently the software object, is changed in dependence on the data. The respective software object may for example be changed once per second. The cycle may however also be shorter or longer. Particularly suitable is a cycle of min. 1 ms and max 100 ms.

The use of such a drive takes place for example in the case of strip/wire-pulling installations, in the maritime sector or test benches.

In the case of use in a strip/wire-pulling installation, the drive is expected to meet highest requirements in terms of synchronization quality and constant torque with high dynamics. Here it is possible for the variables obtained in the process, for example in relation to the material thickness, and the synchronization fluctuations to be influenced, and possibly Immediately corrected, with a high sampling rate by the control software directly, by way of the inverters that are present for each slot.

In the case of use as a maritime drive, into the MW range, the compact machine construction, the noise and vibration behavior as well as the energy efficiency and high availability are at the forefront, depending on the task of the drive. Feedback from sensors, for example on the outer wall of the ship (vibration, structure-borne sound) allow minimal drive-side effects to be set by way of the slot current converters. To achieve optimum energy efficiency, depending on the power requirement, individual slots may be switched off and, if need be, switched on again. Similarly, selective switching off of defective slot current converters makes it possible for the drive to continue operating with unchanged drive power (part load) or reduced drive power (rated load).

If the drive is part of a test bench (automotive, transmissions, etc.), the high requirements for the synchronization quality (low pulsating torques), speed control range and the rotational dynamics. An extended speed control range is already obtained as a result of the structural design of the drive. Eliminating the winding overhangs allows the bearing span to be reduced, and consequently the control range to be extended. In addition, the selective influencing of the vibration excitation by way of the slot current converters allows resonances to be damped, i.e. blocking zones to be avoided.

The invention and further advantageous refinements of the invention are explained in greater detail on the basis of exemplary embodiments shown in principle. The figures should be read as complementing one another to the extent that the same reference signs in different figures have the same technical meaning. The features of the individual embodiments can also be combined with one another. Furthermore, the embodiments shown in the figures can be combined with the features outlined above. It is shown in:

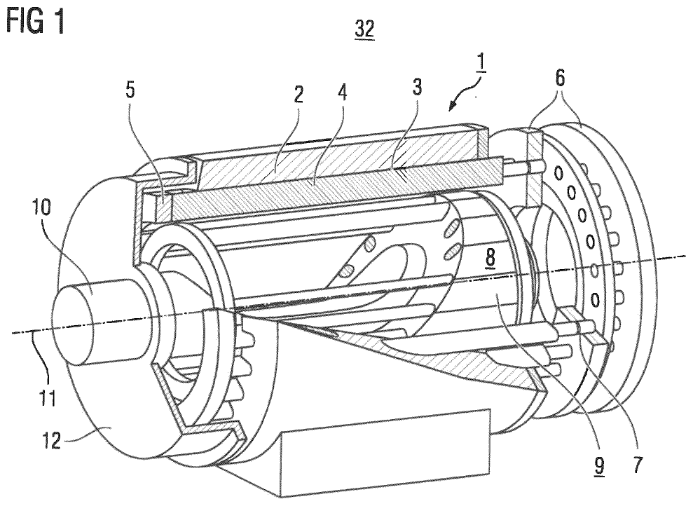

FIG. 1 a partly perspective view of a drive,

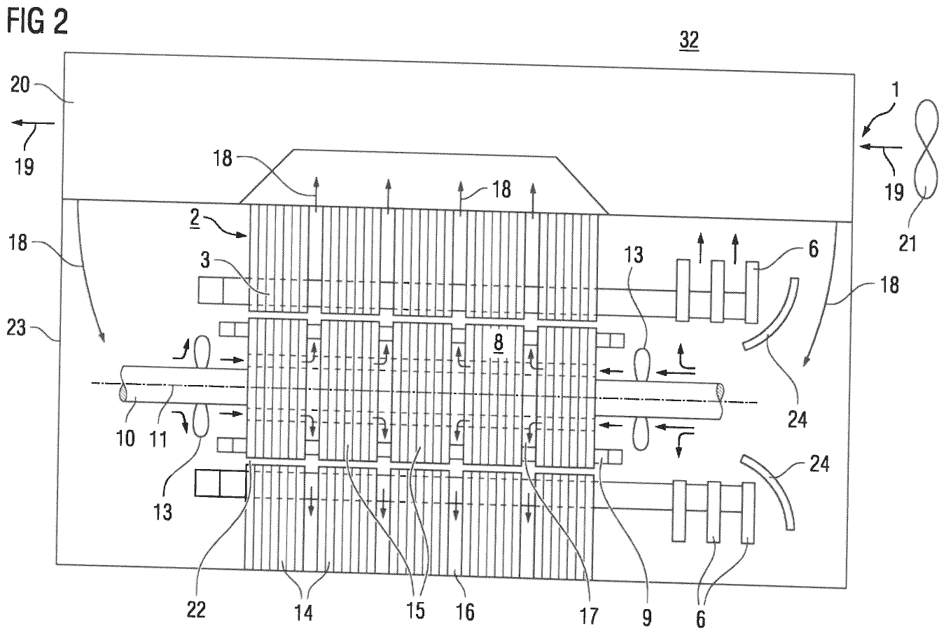

FIG. 2 a basic longitudinal section of a drive,

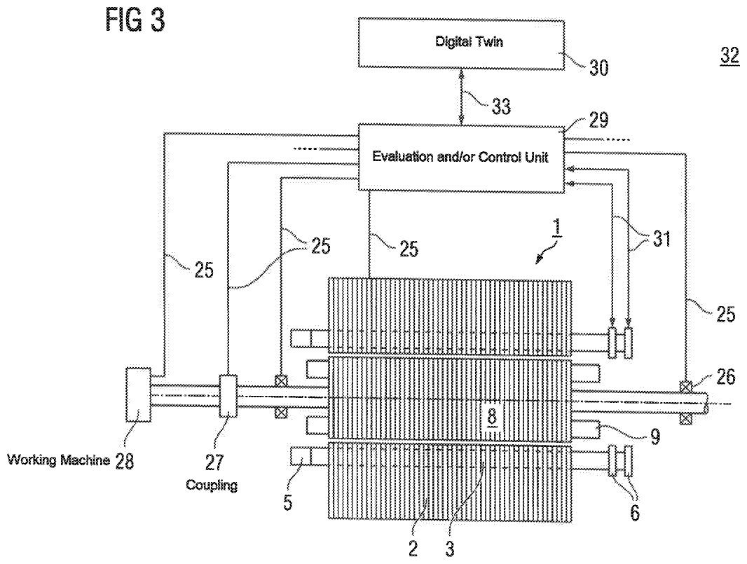

FIG. 3 embedment of a drive in a digitalization environment.

It should be noted that terms such as “axial”, “radial”, “tangential”, etc. refer to the axis 11 used in the respective figure or in the example described in each case. In other words, the directions axial, radial, tangential always refer to an axis 11 of the rotor 8 and thus to the corresponding axis of symmetry of the stator 2. In this case, “axial” describes a direction parallel to the axis 11, “radial” describes a direction orthogonal to the axis 11, toward or away from it, and “tangential” is a direction that is at a constant radial distance from the axis 11 and, in the case of a constant axial position, directed in a circular manner around the axis 11. The expression “in the circumferential direction” is equivalent to “tangential”.

In relation to a surface area, for example a cross-sectional area, the terms “axial”, “radial”, “tangential”, etc. describe the orientation of the normal vector of the area, i.e. the vector that is perpendicular to the area concerned.

The expression “coaxial components”, for example coaxial component parts such as the rotor 8 and the stator 2, is understood here as meaning components that have the same normal vectors, that is to say for which the planes defined by the coaxial components are parallel to one another. Furthermore, the expression is intended also to convey that the center points of coaxial components lie on the same axis of rotation or axis of symmetry. However, these center points may possibly lie at different axial positions on this axis and the planes mentioned may therefore be at a distance of >0 from one another. The expression does not necessarily require that coaxial components have the same radius.

The term “complementary” in connection with two component parts that are “complementary” to one another means that their outer forms are designed in such a way that the one component part can preferably be arranged completely in the component part complementary to it, so that the inner surface of one component part and the outer surface of the other component ideally touch without any gaps or over the entire surface area. Consequently, in the case of two objects that are complementary to one another, the outer form of one object is determined by the outer form of the other object. The term “complementary” could be replaced by the term “inverse”.

For the sake of clarity, sometimes in cases where components are multiply present, in the figures often not all the components shown are provided with reference signs.

The embodiments described below can be combined as desired. Similarly, individual features of the respective embodiments can be combined without departing from the essence of the invention.

FIG. 1 shows in a perspective representation the basic construction of a dynamoelectric machine 1 according to the invention. On one end face of the magnetic conductive body of a stator 2, inverter modules 6 are arranged. On the other end face of the magnetic conductive body of the stator 2 there is a short-circuiting ring 5 of the stator 2, which electrically contacts and short-circuits the individual conductor bars 4 of the stator 2 arranged in slots 3. The magnetically conductive body of the stator 2 is constructed as an axially layered laminated core. A rotor 8 is arranged radially at a distance from the stator 2 by an air gap 22. This rotor 8 is connected for conjoint rotation to a shaft 10 that is rotatable about an axis 11. The rotor 8 is in this case designed with a squirrel cage 9. The magnetically conductive body of the rotor 8 is constructed as an axially layered laminated core.

If there are a number of inverter modules 6 for each conductor bar, the inverter modules 6 are likewise arranged axially layered one after the other. The inverter modules 6 are electrically contacted, in particular with low impedance, by their respective conductors, in particular conductor bars 4 or subconductors, by way of connection elements 7 not shown any more specifically, which can accordingly guide required current intensities (>1000 A) as operating current.

Switching such high currents leads to thermal loading of the respective inverter module 6.

Consequently, between two or more axially and/or radially arranged inverter modules 6, cooling elements which, at least in some portions, are in heat-conducting contact with the adjacent inverter modules 6 are optionally provided between the inverter modules 6.

The shaft 10 is supported on a housing 23 and/or a cover of the dynamoelectric machine 1 by way of bearings 26 and bearing plates.

In the laminated core of the stator 2, axially extending cooling channels may also be provided. Axially extending cooling channels may also be provided in the rotor 8, in its laminated core, radially inside the laminated core of the squirrel cage 9.

On one end face of the stator 2, the respective inverter modules 6 are electrically contacted at the ends of the conductor bars 4, or their subconductors, protruding axially out of this end face.

Each subconductor or each subconductor bundle of a conductor bar 4 is connected to a separate inverter module 6.

The subconductors extend in parallel, at least within the magnetically conductive body of the stator 2.

Similarly at least within the magnetically conductive body of the stator 2, the subconductors may change their position in the slot 3 over the axial course of the slot 3, in particular they may be arranged transposed.

The subconductors are solid or are designed as hollow conductors.

Considered in the circumferential direction, the subconductors are in each case provided, at least in some portions, with an insulating layer.

The short-circuiting ring 5 of the stator 2, as well as the short-circuiting ring of the rotor 8, may be constructed from dividing plates. This makes it possible for example for an air flow 18 to flow radially between these dividing plates of the short-circuiting rings, of the stator 2 and the rotor 8, and thus, on account of the larger surfaces of the short-circuiting rings, to efficiently cool both the short-circuiting rings and the portions of the conductor bars 4 present there and/or the squirrel cage 9 of the rotor 8.

The air flow required for this may be produced by an external fan 21 and/or an own fan 13, which is shown in principle and is connected for conjoint rotation to the shaft 10. The radially delivered air flow is in this case drawn inter alia by way of an axial cooling channel of the rotor 8, with the laminated core of the rotor 8 also being cooled thereby.

In one design, for example as shown in FIG. 2, the laminated core of the stator 2 and the rotor 8 is divided into axially layered partial laminated cores 14, 15, wherein in particular spacers of the rotor 8 may be formed as fan-like elements which during rotation of the rotor 8 generate an own-fan function, and consequently inter alia deliver cooling air from the channel, at least partly, radially through the slit 26 of the rotor 8 and the slit 17 of the stator 2. Cooling air for the slits 16 of the stator 2 may also be provided by way of the air gap 22.

In order to achieve an improved cooling effect, the short-circuiting rings of the stator 2 and the rotor 8 may be arranged axially offset.

An axial distance between the inverter modules 6 also makes efficient air cooling possible.

In principle, the cooling of this drive, that is to say of the dynamoelectric machine 1, with the inverter modules 6 may be formed as open (heat exchange takes place with the ambient air, for example by means of ambient air via air slits in the housing of the machine). As an alternative to this, the cooling of this drive, that is to say of the dynamoelectric machine 1, with the inverter modules 6 may also take place by way of a closed internal cooling circuit (primary circuit 18) within the housing 23; in this case, the recooling of the internal cooling circuit (primary circuit 18) takes place by a secondary cooling device (secondary cooling circuit 19).

FIG. 2 shows a closed internal cooling circuit (primary circuit 18) within the housing 23 with a secondary cooling device (auxiliary cooler 20) for cooling the air flow of the primary circuit 18.

In this case, the auxiliary cooler 20 may be designed as a tube cooler or plate cooler, with the drive (in particular the dynamoelectric machine 1, with the inverter modules 6) in this case undergoing X ventilation on the primary side.

Irrespective of whether ventilation is from one side or two sides (Z or X ventilation) within the dynamoelectric machine 1, the primary circuit 18 is used as a term to refer to an air stream or an air-stream distribution which flows onto and/or flows around and/or flows through component parts of the dynamoelectric machine 1, such as inverter modules 6, short-circuiting rings of the stator 2 and/or the rotor 8, magnetically conductive bodies of the stator 2 and/or the rotor 8, (for example laminated cores or partial laminated cores 14, 15), conductors 8, at least housing portions, bearing plates and bearings 26 and is designed as a closed circuit (internal cooling circuit or primary circuit 18), which has no flow contact with the outside. The air stream of the primary circuit 18 is generated by one or more own fans 13 and/or external fans 21, by pressure or suction, within the housing 23 of the dynamoelectric machine 1.

The secondary circuit 19 is used as a term to refer to a cooling stream, liquid cooling stream (for example on the basis of water) or a gaseous cooling stream (for example on the basis of air) in an auxiliary cooler 20, which is thermally coupled with the cooling stream of the primary circuit 18, can therefore recool it, wherein the cooling stream or a cooling stream distribution, in particular air, of the secondary circuit 19 is generated, by pressure or suction, by own and/or external fans and/or corresponding pumps.

Preferably, the secondary circuit 19 is of an open design, i.e. it is operated with ambient air, sucks in the air from the surroundings, heated by the medium of the primary circuit 18, and subsequently discharges it again to the surroundings. Consequently, the dynamoelectric machine 1, equipped with such an auxiliary cooler 20, can be set up at almost any locations without there being any risk of contamination of the interior of the drive (dynamoelectric machine 1, with the inverter modules 6). All that is required is for the heat exchangers of the auxiliary cooler 20, such as tubes or plates, to be cleaned. In addition, filter mats or air filters for highly contaminated air possibly have to be provided in front of the inlet of the secondary circuit 19.

Each air stream, both of the primary circuit 18 and of the secondary circuit 19, may in this case divide into parallel flow paths, at least in some portions within the course of its flow, in particular during the heat exchange between the primary circuit 18 and the secondary circuit 19, which increases the efficiency of the recooling.

This advantageously takes place by directing devices 24 in the dynamoelectric machine 1 and/or in the secondary circuit 19 formed as an auxiliary cooler 20, in order to optimize the cooling effect of the primary circuit 18 and/or secondary sector 19.

The internal cooling circuit of the dynamoelectric machine 1, with the inverter modules 6—that is to say the primary circuit 18—may be designed as Z or X ventilation.

One-sided ventilation (Z ventilation) of the internal cooling circuit is used as a term to refer to the ventilation of the dynamoelectric machine 1 in which an air stream (primary circuit 18) is fed on one side of the dynamoelectric machine 1 into a winding overhang space and after that passes by way of various parallel and/or serial flow channels—inter alia winding overhang, back of the laminated core of the stator 2, radial cooling channels 16, 17, air gap 22, etc.—to the other winding overhang space. From there, the heated air of the primary circuit 18, driven by way of one or more fans—own fans or external fans—passes into the auxiliary cooler 20 for recooling.

The air of the primary circuit 18 is consequently guided by way of a winding overhang space into the housing 23 of the dynamoelectric machine 1 and there is guided inter alia by way of the winding overhang and the laminated cores and/or the air gap 22 into the other winding head space. From there, the then possibly further-heated cooling air stream is recooled by way of the auxiliary cooler 20, by means of the secondary circuit 19.

Two-sided ventilation (X ventilation) of the internal cooling circuit is a term used to refer to the ventilation of the dynamoelectric machine 1 in which an air stream (primary circuit 18) is fed into the respective winding overhang space on both sides of the dynamoelectric machine 1 and after that passes by way of various parallel and/or serial flow channels—inter alla winding overhang, back of the laminated core of the stator 2, radial cooling channels 16, 17, air gap 22, etc.—substantially centrally on the back of the stator laminated core into the auxiliary cooler 20. The heated air of the primary circuit 18 is consequently delivered by one or more fans—own fans or external fans—into the auxiliary cooler 20 for recooling. Corresponding, in particular adjustable, baffle elements, such as nozzle elements, improve the flow profile of the primary circuit 18, in that flow can be specifically directed to particular “hot spots” (for example inverter modules 6) within the primary circuit 18.

The secondary circuit 19—that is to say the auxiliary cooler 20—of the dynamoelectric rotary machine 1 may be formed as a tube cooler or plate cooler, the cooling medium of which is air or water. Such closed primary cooling circuits 18 can best be implemented on the secondary side with the following auxiliary coolers 20 (air-air cooling units via tube or plate coolers: or air-liquid cooling units via at least partially circumferential jacket coolers or auxiliary coolers).

The auxiliary cooler 20 has in this case channels or flow paths (not shown any further) of the primary circuit 18 and the secondary circuit 19. It also has corresponding matching openings with the housing 23, in order to realize the respective cooling principles.

Adjustable directing devices 24, such as nozzle elements or baffle elements, guide and/or branch the air stream of the primary circuit 18 within the housing 23 to the respective heat sources.

Directing devices of the cooling air stream may also be provided in the secondary circuit 19.

Such a drive, that is to say the dynamoelectric machine 1, with conductor bars 4 or subconductors that can be separately activated by way of inverter modules 6, is suitable especially for industrial installations where greatly varying operating conditions are required, and where control-related reactions of the drive are necessary within a very short time. (Adaptation of a magnetic axial or radial pull, reaction to vibrations of the rotor, adaptations of the rotational speed, redundancy of the machine 1 in the event of failure of a conductor bar 4 or its inverter modules 6, etc.).

FIG. 3 shows a drive, that is to say the dynamoelectric machine 1, with its inverter modules 6, wherein the shaft 10 drives a working machine 28 (not shown any more specifically) by way of a coupling 27. The data of the drive that are picked up by sensors are passed on in a cable-bound or cableless manner to a control 29 by way of data connections 25.

Sampling rates or time constants in the evaluation or control are predeterminable and are taken into account according to the types of sensor (recording of physical or chemical parameters such as temperature, vibration, abrasion, etc.).

In principle, the data of a sensor of the control positioned at any point on and/or in the drive can consequently be transmitted, taken into account in a control strategy and, resulting from this, be predetermined for the allocated inverter modules 6, and consequently entire drive and/or machine behavior can be corrected to this extent.

On account of the large number of possibilities for controlling this drive, a correspondingly large number of sensors for real-time monitoring can be positioned on and in the drive.

These sensors consequently also deliver data for a digital twin 30 or else maintenance intervals, and possibly data of an optimization for subsequent models of these drives.

In addition or as a result, knowledge of the electrical variables at slot level or even subconductor level allows the component stresses (for example vibration dampers at the motor foot; loads on the bearings 26; loads on the coupling 27 in relation to the working machine, etc.) to be very strictly limited, which leads to considerably improved state analysis and lifetime assessment. Maintenance intervals of the drive can consequently be maxed out.

FIG. 3 shows by way of example that a control can feed all of the data of the drive, the bearings, the coupling, the working machine, temperatures of cooling media (not shown), sound emissions, torsional vibrations of the shaft, etc. to the control of the drive.

These data can be used to “feed” a digital twin 30, which also allows feedback to the drive, and its way of working to be influenced.

With the digitalization especially of such a drive, which creates control interventions to slot level or even subconductor level, with the possibility of intervening in a controlling manner in the machine behavior of the current operation of the drive from the control and/or even on the basis of the digital twin, a series of advantages for the electric machine and/or a working machine are obtained.

This consequently allows the vibration behavior, the noise behavior and the pulsating torques to be minimized, while at the same time maximizing the efficiency of the drive. Similarly, the synchronization properties are thereby improved.

The constant analysis of the actual state of the current drive and also a compilation of data in the digital twin of other drives of the same type allow the analysis of the individual component stress to be improved. This also leads to an improvement in availability assessment of the drive.

Data transfer can take place synchronously or asynchronously (in data blocks). Similarly, data transfer is possible unidirectionally and bidirectionally.

Depending on the dynamics of the data monitored and/or recorded, data transfer rates may be several bits/s to Mbits/s.

What is claimed is:

1.-8.(canceled)

9. A drive, comprising a rotary dynamoelectric machine, said rotary dynamoelectric machine comprising:
a number of inverter modules;
a rotor;
a stator separated from the rotor by an air gap and comprising a magnetically conductive body and a winding system arranged in slots of the magnetically conductive body, which slots face the air gap, said winding system comprising for each of the slots a conductor bar divided into subconductors which are in electrical contact with at least one of the inverter modules at a first end of the conductor bar and are electrically combined with other ones of the subconductors of other ones of the conductor bars arranged in corresponding ones of the slots to form a short-circuiting ring at a second end in facing relation to the magnetically conductive body of the stator;
a predeterminable number of physical and/or chemical sensors, which are assigned to at least one or more portions of the rotary dynamoelectric machine and/or one or more of the inverter modules and provided on and/or within the drive; and
an evaluation and/or control unit designed to enable a provisional evaluation of data recorded by the sensors and to communicate to a cloud and/or to the inverter modules in predeterminable time intervals and/or data packets;
wherein the drive is designed to actively monitor and influence to a slot level, and to record and adjust current and voltage to the slot level or to a subconductor level of the conductor bar to thereby intervene a behavior of the rotary dynamoelectric machine in a controlling manner.

10. The drive of claim 9, wherein the magnetically conductive body is a laminated core.

11. The drive of claim 9, wherein the drive is designed to actively monitor and influence to the slot level by setting a magnetic pull, a synchronization quality and a predeterminable torque with high dynamics by way of the control and/or the inverter modules.

12. The drive of claim 9, wherein at least one of the subconductors of the conductor bar is connected to a corresponding one of the inverter modules or for each slot the conductor bar is made in one piece connected to the corresponding one of the inverter modules.

13. The drive of claim 12, wherein the subconductors are combined to a subconductor bundle connected to the corresponding one of the inverter modules.

14. The drive of claim 9, wherein the sensors record operating parameters and pass the operating parameters on to the evaluation and/or control unit.

15. The drive of claim 14, wherein the operating parameters include a vibration behavior of the stator or the rotor, noise behavior, pulsating torque, or synchronization property.

16. The drive of claim 14, wherein the sensors are designed to transmit data commensurate with the operating parameters recorded by the sensors in a cable-bound or cableless manner to the evaluation and/or control unit.

17. A method for operating and/or monitoring and/or simulating the drive of claim 9, the method comprising:
recording at least some of the data in and on the drive by sensors and/or recording elements;
transmitting the data recorded to an evaluation and/or control unit designed to execute at least a provisional evaluation of the data; and
depending on the evaluation of the data, selectively recording, evaluating, monitoring and controlling operating parameters by way of the inverter module or inverter modules to subconductor levels of the stator of the dynamoelectric machine so as to enable to intervene behavior of the dynamoelectric machine in a controlling manner.

18. The method of claim 17, wherein the operating parameters include voltage and/or current.

19. A digital twin system of the drive of claim 9, the digital twin comprising:
a physical part embodied by the physical drive for driving a working machine;
a virtual part comprising a digital image of the drive;
sensors and recording elements for recording data of the drive inside and/or outside the drive; and
a data transfer element designed to transfer data between the physical part and the virtual part so that when the data is transferred to the virtual part, the digital image of the drive is changeable in dependence on the data transmitted.

20. The digital twin system of claim 19, wherein the physical drive, in particular the inverter modules or at least individual inverter modules, is actively influenced by way of the data transfer element from the evaluation and/or control unit or the virtual drive.

21. A computer program product, comprising a computer program embodied in a non-transitory computer readable medium, wherein the computer program, when loaded into a computer and executed by the computer, causes the computer simulate an operating behavior of the drive of claim 9.
